(19) United States
(12) Patent Application Publication
(10) Pub. No.: US 2009/0243511 A1
(43) Pub. Date: Oct. 1, 2009

(54) Stabilized high power LED module

(76) Inventor: Baoliang Wang, Baldwin Park, CA (US)

Correspondence Address: DAVID AND RAYMOND PATENT FIRM, 108 N. YNEZ AVE., SUITE 128, MONTEREY PARK, CA, 91754, US

(21) Appl. No.: 12/215,566

(22) Filed: Jun. 27, 2008

(30) Foreign Application Priority Data
Mar. 25, 2008 (CN) 200820092913.0

(51) Int. Cl. F21V 21/00; H05B 37/02; H05B 41/36

(52) U.S. Cl. 315/294; 315/185 R; 362/217.15; 315/291

(57) ABSTRACT

A stabilized high power LED module includes a supporting frame and an illuminating unit. The supporting frame is made of thermal conductive material for radiating heat produced by the illuminating unit. The illuminating unit includes a light circuit supported by the radiating supporting frame, and a plurality of illuminators which are electrically mounted to the light circuit and spacedly aligned along the supporting frame, wherein the light circuit has a voltage regulation preset for the illuminators in series to stabilize a voltage supply of the light circuit for protecting the illuminators.

### BACKGROUND OF THE PRESENT INVENTION

1. Field of Invention

The present invention relates to a LED module, and more particularly to a stabilized high power LED module, which is capable of emitting high intensity light with a stable operation for enhancing the service life span of the LED module.

2. Description of Related Arts

Neon lights have long been utilized for a wide variety of lighting purpose, notably for advertisements, traffic lights, constructions and domestic decoration. Some kinds of neon lights are capable of producing high intensity of light, so that people prefer using neon lights instead of the traditional LED lights because the light from the neon light is brighter than the light from the traditional LED light.

Despite the advantages and popularity of the conventional neon lights, they definitely have discrepancies. First of all, neon lights need 10 K volt power supply, which is obtained by a specialized neon lights transformer. Once the insulation wire connector at an output of the high voltage transformer accumulates dirt thereon, the connector will be shorted and get burned due to increasing power consumption, especially in wet weather. Once the wire connecting the transformer and the electrode are overload or the insulation coat of the wire is aged, the neon lights may be shorted and get fired.

Second, the conventional neon lights use high voltage, so that the power consumption is extremely high. And further more, the conventional neon lights will generate a substantial amount of heat when operating and therefore inevitably produce a substantial amount of energy waste. In addition, a practical disadvantage of them is that they are generally fragile. As a matter of fact, the neon lights do not have any protection ability, which is easily get leakage, broken, and vulnerable to external forces,

Due to the above discrepancies, there exists another type of illuminating device which is generally called the LED. Conventionally, each LED is capable of generating light in a very efficient manner. It consumes less energy than conventional neon lights, usually non-fragile, and generates only very little amount of heat when operating. One reason for this is that for LED, most energy inputted will be converted into light (i.e. electromagnetic wave with visual wavelength). Thus, as most energy inputted is converted into light, less heat is generated.

However, the LED generally produces lower light intensity. In order to increase the light intensity of the LED, a larger electric power can be applied to the LED, so as to increase the electrical power thereof. However, due to the structure of the LED, when increasing the current, heat generated from the LED will burn LED, and the problem of constant current driver limits the development of the light intensity of LED.

Another way to increase the light intensity of the LED is to connect a plurality of LEDs in serial to form a LED module. However, the heat of each LED is accumulated, so as to shorten the life-span of the LED module. Therefore, a heat sink must be incorporated well to efficiently dissipate the heat.

### SUMMARY OF THE PRESENT INVENTION

A main object of the present invention is to provide a stabilized high power LED module, which is capable of emitting high intensity light with a stable operation to enhance the service life span.

Another object of the present invention is to provide a stabilized high power LED module, which has a voltage regulation to regulate the voltage of the LED module, so as to prolong a life-span of LED and lower an attenuation of LED.

Another object of the present invention is to provide a stabilized high power LED module, wherein at least two LEDs are electrically connected in series, so as to increase a light intensity of the LEDs.

Another object of the present invention is to provide a stabilized high power LED module, wherein an outer casing is capable of effectively radiating heat produced by the LEDs connected in series.

Accordingly, in order to accomplish the above object, the present invention provides a stabilized high power LED module, comprising:

a supporting frame made of thermal conductive material, and

an illuminating unit comprising a light circuit supported by the radiating supporting frame, and a plurality of illuminators which are electrically mounted to the light circuit and spacedly aligned along the supporting frame, wherein the light circuit has a voltage regulation preset for the illuminators in series to maintain a constant voltage level for the light circuit so as to provide an optimized operation condition for the illuminators and to prolong a service life span thereof.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a stabilized high power LED module according to a preferred embodiment of the present invention.

FIG. 2 is an exploded perspective view of the stabilized high power LED module according to the above preferred embodiment of the present invention.

FIG. 3 is a circuit diagram of the stabilized high power LED module according to the above preferred embodiment of the present invention.

FIG. 4 is a first alternative mode of the stabilized high power LED module according to the above preferred embodiment of the present invention.

FIG. 5 is an exploded perspective view of the first alternative mode of the stabilized high power LED module according to the above preferred embodiment of the present invention.

FIG. 6 is a second alternative mode of the stabilized high power LED module according to the above preferred embodiment of the present invention.

### DETAILED DESCRIPTION OF THE PREFERRED EMBODIMENT

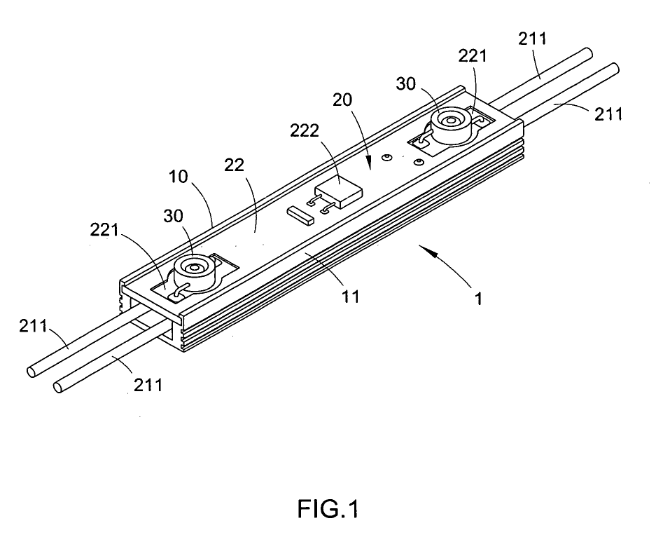

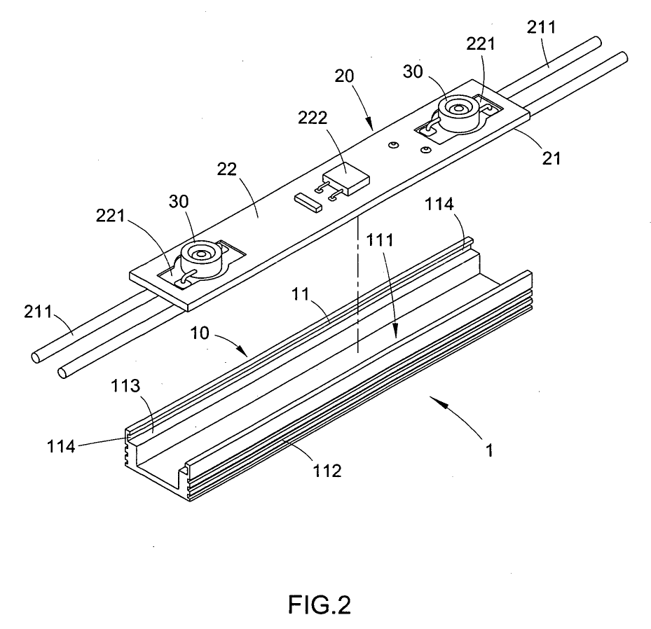

Referring to FIG. 1 and FIG. 2 of the drawings, a stabilized high power LED module according to a preferred embodiment of the present invention is illustrated, in which the stabilized high power LED module 1 comprises a supporting frame 10 and an illuminating unit.

The supporting frame 10 is made of thermal conductive material for radiating heat produced by the illuminating unit. The illuminating unit comprises a light circuit 20 supported by the supporting frame 10, and a plurality of high power illuminators 30 which are electrically mounted to the light circuit 20 and spacedly aligned along the supporting frame 10, wherein the light circuit 20 comprises a voltage regulator 222 preset a voltage regulation for the illuminators 30 in series to maintain a constant voltage level for the light circuit 20 so as to provide an optimized operation condition for the illuminators 30 and to prolong a service life span thereof. In other words, the voltage regulator 222 provides a constant current to the light circuit 20 such that the illuminators 30 are effectively operated under the optimized current condition. Therefore, the life span of the illuminators 30 can be extended in comparison with the conventional illuminators working under an irregular current level.

The supporting frame 10 comprises an elongated casing 11. As mentioned above, the elongated casing 11 is made of good thermal conductive, such as aluminum. The elongated casing 11 has two side walls 114 spaced apart forming an elongated channel 111 for receiving the light circuit 20 and high power illuminators 30 thereat. An elongated retaining groove 113 is provided at an inner side of each of the side walls 114.

The light circuit 20 comprises a circuit board 21 for mounting the high power illuminators 30 and the voltage regulator 222 thereon. Two edge portions of the circuit board 21 are slidably inserted into the two elongated retaining grooves 113 respectively so as to mount the light circuit 20 at the elongated casing 11 along the elongated channel 111.

At least one radiation groove 112, which is an elongated groove, is provided at an outer side of each of the side walls 114 to enlarge a radiation area of the elongated casing 11. As shown in FIG. 2, two or more of the radiation grooves 112 are indently formed on each of the side walls 114, wherein the radiation grooves 112 are extended longitudinally and spacedly aligned at the outer side of the respective side wall 114 for enhancing the head radiation of the high power illuminators 30. The radiation grooves 112 can be transversely or longitudinally provided at an outer side of the two side walls 114 to enlarge the radiation area for head radiation.

Alternatively, each of the side walls 114 of the elongated casing 11 has at least one radiation projection protruded from the outer side of the side wall 114, so as to enlarge the radiation area. Likewise, two or more radiation projections are spacedly protruded from the outer side of the respective side wall 114 for enhancing the head radiation of the high power illuminators 30. The radiation projection can be transversely or longitudinally provided at an outer side of the two side walls 114 as long as the radiation projections can enlarge the radiation area for head radiation

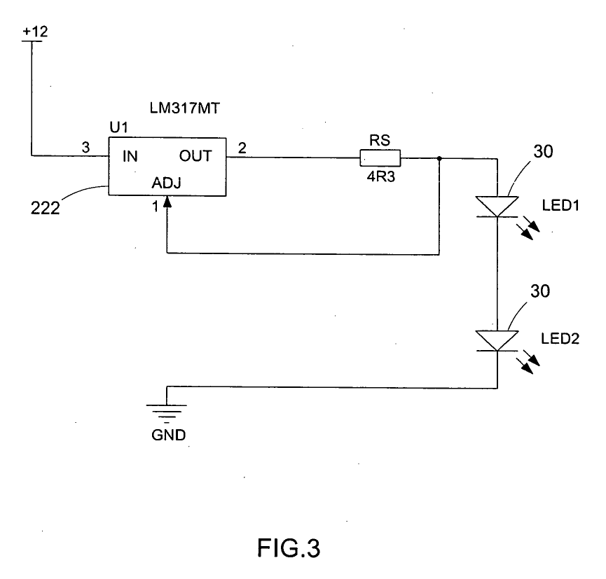

The light circuit 20 comprises at least two light housings 221 spacedly aligned on a top surface 22 of the circuit board 21 for holding the high power illuminators 30 respectively. The voltage regulator 222 is positioned between the light housing 221 for saving space. The light circuit 20 further comprises an electric wire 211 for electrically connecting the light housings 221 and the voltage regulator 222, wherein the electric wire 211 is electrically extended from the bottom side of the circuit board 21 and is extended out of the elongated casing 11 at the side opening thereof. The lights housings 221 and the voltage regulator 222 are connected in series, as shown in FIG. 3, so that the illuminators 30 mounted on the light housings 221 can be electrified and illuminated. Accordingly, the voltage regulator 222 is a three-terminal voltage regulator (LM317MT), wherein the illuminators 30 are powered by a 12V DC supply as shown in FIG. 3.

The high power illuminator 30 in the present invention is high power LED, and the LEDs in the preferred embodiment are 1 W. A 12V DC power supply is used in the preferred embodiment to supply power to the high power LED. Of course the LEDs may have different colors, such as red, yellow, green, white, blue and so on, on different occasions.

Because the large power LED produces more heat than low power LED, so that the thermal conductive structure for supporting frame 10 is used for radiating heat, and the radiation grooves 112 ensure the heat to be radiated in time, so as to prolong the lifespan of the high power LEDs.

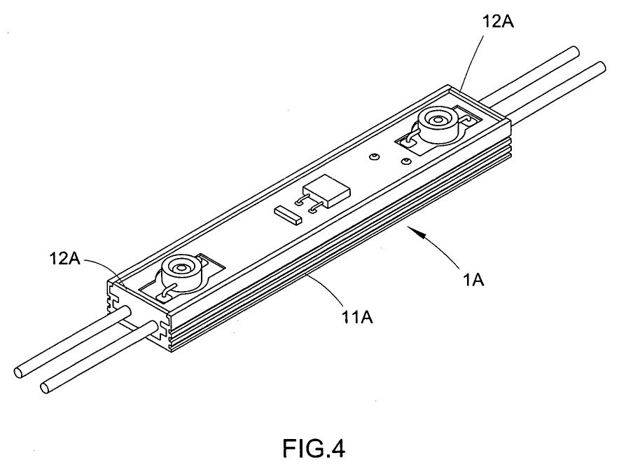

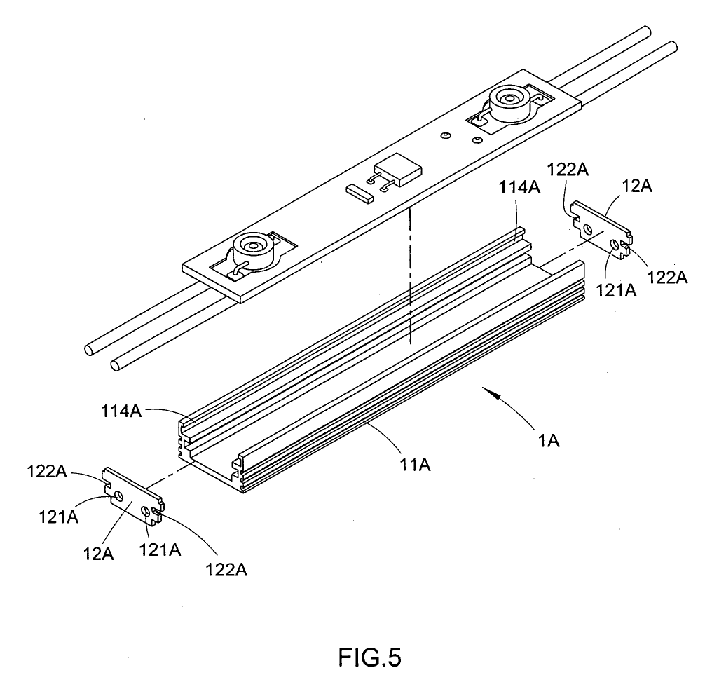

Furthermore, referring to FIG. 4 and FIG. 5 of the drawings, an alternative mode of the stabilized high power LED module 1A is illustrated, wherein the elongated casing 11A further comprises two retaining caps 12A provided at two side openings of the elongated casing 11A respectively to enclose the elongated channel for retaining the circuit board in position.

Each of the retaining caps 12A has at least a guiding hole for the electric wire 211 passing through. The retaining cap 12A has two side wings 122A extending sidewardly for being inserted into the retaining groove 113 for retaining the circuit board inside the elongated channel of the elongated casing 11A.

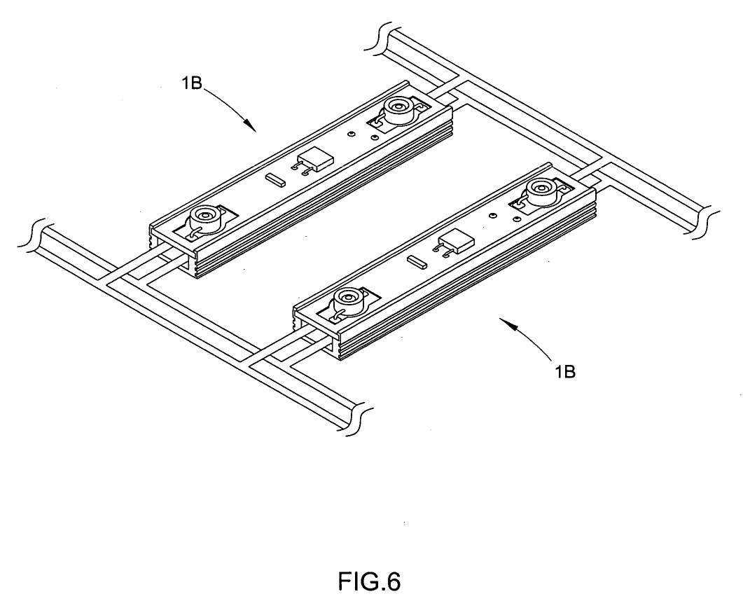

Referring to FIG. 6 of the drawings, a second alternative mode of the present invention is illustrated, wherein two stabilized high power LED modules 1B are connected in parallel. Therefore, a plurality of stabilized high power LED modules 1B can be used together.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A stabilized LED module, comprising:
a supporting frame made of thermal conductive material for radiating heat; and
an illuminating unit comprising a light circuit supported by said supporting frame, and a plurality of illuminators which are electrically mounted to said light circuit and spacedly aligned along said supporting frame, wherein said supporting frame comprises an elongated casing having two spaced apart side walls and forming an elongated channel therebetween for receiving illuminating unit therein, wherein said light circuit comprises a circuit board mounting between said side walls of said elongated casing along said elongated channel.

2. The stabilized LED module, as recited in claim 1, wherein said light circuit has a voltage regulation preset for said illuminators to maintain a constant voltage level for said light circuit so as to provide an optimized operation condition for said illuminators and to prolong a service life span thereof.

3. The stabilized LED module, as recited in claim 2, wherein said illuminating unit comprises a voltage regulator, presetting said voltage regulation, electrically coupled with said illuminators in series.

4. The stabilized LED module, as recited in claim 1, wherein each of said side walls has an elongated retaining groove provided at an inner side thereof such that two edge portions of said circuit board are engaged with said retaining grooves respectively.

5. The stabilized LED module, as recited in claim 3, wherein each of said side walls has an elongated retaining groove provided at an inner side thereof such that two edge portions of said circuit board are engaged with said retaining grooves respectively.

6. The stabilized LED module, as recited in claim 4, wherein said elongated casing further has a plurality of radiation grooves indently formed at an outer side of each of said side walls for enlarging a radiation area of said side wall for heat radiation, wherein said radiation grooves, which are elongated grooves, are spacedly and alignedly indented on said outer side of each of said side walls.

7. The stabilized LED module, as recited in claim 5, wherein said elongated casing further has a plurality of radiation grooves indently formed at an outer side of each of said side walls for enlarging a radiation area of said side wall for heat radiation, wherein said radiation grooves, which are elongated grooves, are spacedly and alignedly indented on said outer side of each of said side walls.

8. The stabilized LED module, as recited in claim 5, wherein said light circuit comprises two or more light housings spacedly provided on a top surface of said circuit board to house said illuminators respectively, wherein said voltage regulator is positioned between said light housings to electrically couple with said illuminators.

9. The stabilized LED module, as recited in claim 7, wherein said light circuit comprises two or more two light housings spacedly provided on a top surface of said circuit board to house said illuminators respectively, wherein said voltage regulator is positioned between said light housings to electrically couple with said illuminators.

10. The stabilized LED module, as recited in claim 5, wherein said light circuit further comprises an electric wire electrically extending from a bottom side of said circuit board and extending out of said elongated casing through a side opening thereof.

11. The stabilized LED module, as recited in claim 9, wherein said light circuit further comprises an electric wire electrically extending from a bottom side of said circuit board and extending out of said elongated casing through a side opening thereof.

12. The stabilized LED module, as recited in claim 10, wherein said elongated casing further comprises two retaining caps coupled at said side openings of said elongated casing respectively to enclose said elongated channel, wherein each of said retaining caps has a guiding hole arranged in such a manner that said electric wire is extended out of said elongated casing through said guiding hole of said respective retaining cap.

13. The stabilized LED module, as recited in claim 11, wherein said elongated casing further comprises two retaining caps coupled at said side openings of said elongated casing respectively to enclose said elongated channel, wherein each of said retaining caps has a guiding hole arranged in such a manner that said electric wire is extended out of said elongated casing through said guiding hole of said respective retaining cap.

14. The stabilized LED module, as recited in claim 12, wherein each of said retaining caps further has two side wings sidewardly extending to engage with said retaining grooves of said elongated casing respectively so as to retain said circuit board in position.

15. The stabilized LED module, as recited in claim 13, wherein each of said retaining caps further has two side wings sidewardly extending to engage with said retaining grooves of said elongated casing respectively so as to retain said circuit board in position.

16. The stabilized LED module, as recited in claim 1, wherein each of said illuminators is a 1 W LED, wherein said illuminators are powered by a 12V DC supply.

17. The stabilized LED module, as recited in claim 15, wherein each of said illuminators is a 1 W LED, wherein said illuminators are powered by a 12V DC supply.

18. The stabilized LED module, as recited in claim 3, wherein said voltage regulator is a three-terminal voltage regulator, wherein said supporting frame is made of aluminum.

19. The stabilized LED module, as recited in claim 7, wherein said voltage regulator is a three-terminal voltage regulator, wherein said supporting frame is made of aluminum.

20. The stabilized LED module, as recited in claim 17, wherein said voltage regulator is a three-terminal voltage regulator, wherein said supporting frame is made of aluminum.
